(19) United States
(12) Patent Application Publication
(10) Pub. No.: US 2016/0055212 A1
(43) Pub. Date: Feb. 25, 2016

(54) AUTOMATIC JOINING OF DATA SETS BASED ON STATISTICS OF FIELD VALUES IN THE DATA SETS

(71) Applicant: Attivio, Inc., Newton, MA (US)

(72) Inventors: Jonathan Young, Newton, MA (US); John O'Neil, Watertown, MA (US); William K. Johnson, III, Natick, MA (US); Martin Serrano, Andover, MA (US); Gregory George, Sudbury, MA (US)

(21) Appl. No.: 14/466,231

(22) Filed: Aug. 22, 2014

(51) Int. Cl. G06F 17/30

(52) U.S. Cl. CPC G06F 17/30498; G06F 17/3053

(57) ABSTRACT

A computer system processes arbitrary data sets to identify fields of data that can be the basis of a join operation. Each data set has a plurality of entries, with each entry having a plurality of fields. For each pair of data sets, the computer system compares the values of fields in a first data set in the pair of data sets to the values of fields in a second data set in the pair of data sets, to identify fields having substantially similar sets of values. Given pairs of fields that have similar sets of values, the computer system measures entropy with respect to an intersection of the sets of values of the pair of fields. The computer system can recommend fields for a join operation between any pair of data sets in the plurality of data sets based on such statistical measures.

### BACKGROUND

In large data sets with multiple tables of information, an operation called a “join” is commonly performed to generate reports in response to queries.

For example, a table of data about people may include an entry (or row) for each person (such as each employee of a company). Each entry includes data in fields (or columns), where that data represents the person. For example, the table can have an identifier field (or column) for each entry, which stores a value which should be unique for each person. Similarly, a table of data about locations may include an entry (or row) for each location (such as each office for a company). Each entry includes data in fields (or columns), where that data represents the location, such as address data. The table also can have an identifier field (or column) for each entry which stores a value which should be unique for each location. Another table may include associations between people and locations. Each entry in this table provides at least the identifier of the person and the identifier of the location to which that person is assigned.

Without joining tables, generating a report listing employees and their addresses would involve accessing each of these three tables to obtain all of the information for the report. Joining involves combining the data from among the tables into another data set that can be processed as a combined table. For example, a possible result of joining the three tables above would be a single table with an entry for each person, including their names, identifiers, office identifiers and office addresses. How the tables are combined can be described as an inner join or outer (left or right) join.

Joining database tables is generally easy if the database tables are all designed by the same person or team of people, and the designs are coordinated. Joining tables also is generally easy if different tables still have the same field names and data types for fields that store the same data, such as the identifiers in the example above. Joining tables becomes more complex when the tables arise from separate and distinct databases with different table structures without any design coordination, often called “silos”. Joining tables also is more complex if the data sets are arbitrary and generated from unstructured data.

### SUMMARY

This Summary is provided to introduce a selection of concepts in a simplified form that are further described below in the Detailed Description. This Summary is intended neither to identify key or essential features, nor to limit the scope, of the claimed subject matter.

A computer system processes arbitrary data sets to identify fields of data that can be the basis of a join operation, which in turn can be used in report and query generation. Each data set has a plurality of entries, with each entry having a plurality of fields. Each field can have one or more values, but it is possible for record to be missing a value in the field. Given such data sets, then, for each pair of data sets, the computer system compares the values of fields in a first data set in the pair of data sets to the values of fields in a second data set in the pair of data sets, to identify fields having substantially similar sets of values. Given pairs of fields that have similar sets of values, the computer system measures entropy with respect to an intersection of the sets of values of the identified fields from the pair of data sets. The computer system can perform other statistical analyses on the fields or the multiset intersection of those fields. The computer system can recommend or select fields for a join operation between any pair of data sets in the plurality of data sets, based at least on the measured entropy with respect to the intersection of the sets of values of the identified fields from the pair of data sets and optionally other statistical measures.

The invention may be embodied as a computer system, as any individual component of such a computer system, as a process performed by such a computer system or any individual component of such a computer system, or as an article of manufacture including computer storage on which computer program instructions are stored and which, when processed by one or more computers, configure those computers to provide such a computer system or any individual component of such a computer system.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a data flow diagram of an example application environment in which a computer system supports discovery and suggestion of joins between arbitrary data sets.

FIG. 2 is a diagram of an illustrative example of data sets to be analysed for recommending join operations.

FIG. 3 is a diagram of an illustrative example of analysis data sets extracted from the plurality of data sets for performing statistical analyses.

FIG. 4 is a flowchart describing an example operation of processing the analysis data from multiple data sets to suggest fields for joins.

FIG. 5 is a flowchart describing an example operation of the statistical analysis performed on a pair of fields from different data sets.

FIG. 6 is a diagram of an illustrative example of a data structure for maintaining statistical analysis results performed on two data sets.

FIG. 7 is a flow chart describing an example implementation of applying statistical analyses to a pair of fields from two data sets.

FIG. 8 is a block diagram of an example computer with which components of such a system can be implemented.

### DETAILED DESCRIPTION

The following section describes an example operating environment of a computer that processes data sets to identify or recommend fields in those data sets that can be the basis for a join operation.

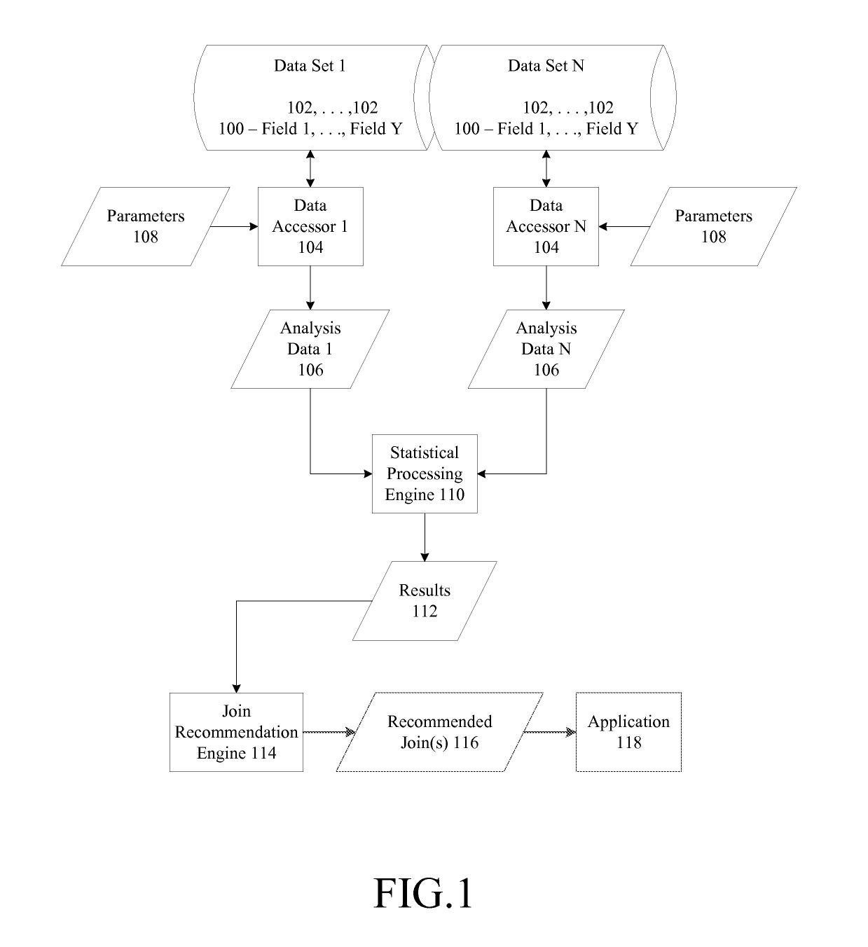

Referring to FIG. 1, a plurality of data sets 1 . . . N are shown. A data set also may be called a table or class. Each data set has a plurality of entries 100, which may also be called records, or rows, or objects, with each entry having a plurality of fields 102, which may also be called columns, or attributes, or variables. A field may have a value, or may be empty or have a null value. In some implementations, a data set can have multiple values for a field. For the purposes of finding joins, in general there are at least two fields per data set, and there are at least two data sets.

In general, such data sets are stored in persistent storage, whether in data files accessible through a file system or as a database, typically accessible through a database management system, such as a relational database or object oriented database.

For analysis, to identify fields for joining the data sets, data from data sets are read from persistent storage into memory where they can be accessed more readily by processing units. The structure of such data may be one or more tables in a relational database, one or more objects in an object oriented database, or one or more indexes of structured, semi-structured, or unstructured data. Such an index can be stored in a format such as an inverted index, in which includes, for each field value, a pointer or other reference to each document which contains that field value.

As shown in FIG. 1, one or more computer programs (called herein data accessors 104) cause a computer to perform the function of reading data from data sets 1 . . . N in persistent storage into memory for analysis. A statistical sampling of a data set can be performed to avoid processing the entire data set. Such a computer program uses available constructs for accessing the data from data sets 1 . . . N and generates analysis data 106 in memory.

In general, analysis data 106 is structured as one or more ordered data structures, such as an array, list, matrix or the like, in which each value is stored at an indexed location. In general, from each data set, separately accessible analysis data is generated for each field which has been selected for analysis from the data set. The analysis data from a data set can be structured, for example, as a one-to-one mapping of values from a field to values in a data structure (e.g., an array), or can be a many-to-one mapping of values from multiple fields to values in a data structure (e.g., a matrix).

In addition to making the data accessible in memory for access by a processor for analysis, data accessors can perform various data transformations to allow easier comparison of data between different fields. For example, the data accessor may convert a data type of the data from a stored data type (in storage) to an analysis data type (in memory). In practice, the data type of most fields is a string, but some may be integers (signed or unsigned), floating point integers, dates and so on.

The different kinds of variations which can be programmed into a data accessor (depending, for example, on the type of persistent storage, available data sets, data types in the available data sets, and data structures and data types used in analysis data sets) are shown in FIG. 1 as parameters 108. Such an illustration is provided merely to indicate that there are variations to such data accessors that can be different across implementations, and not to suggest that a parameterized implementation is required. Each data accessor 104 can be a custom computer program depending on other requirements of the implementation.

Given analysis data for a pair of data sets, the analysis data can be subjected to various statistical processing to identify fields, if any, which are similar enough to support a join operation between the data sets. One or more computer programs cause a computer to perform such statistical processing, as illustrated in FIG. 1 as statistical processing engine 110. An example implementation of such a statistical processing engine will be provided in more detail below.

The output of the statistical processing engine is one or more statistical results 112. Example implementations of data structures for such statistical results will be described in more detail below. Generally, the statistical results include, for each pair of fields, in addition to an identification of the fields in the pair, a set of values resulting from the statistical analyses performed between the two fields. Such statistical results can include, for example, a measure of similarity of the sets of values in the two fields, a measure of entropy with respect to an intersection of the sets of values of the identified fields, a measure of density of one or both fields or a measure of a likelihood that a value in the identified field in the first data set matches a value in the identified field in the second data set.

The statistical results 112 are input to a recommendation engine 114 which provides, as its output, one or more recommended joins 116, which can be provided to applications 118. Each recommended join is a pair of fields, one field from each data set. The recommendation engine can output a list of such recommended joins. The list of joins can be sorted or unsorted. The recommendation engine 114 or an application 118 can present such a list to a user through a display or other output device, and the user can provide one or more selected joins through an appropriate input device. The application 118 also can use the list to select one or more joins.

A variety of applications can take advantage of a selected join pair. For example, various queries, whether computer generated or user generated, can be applied to the joined data sets. For example, user queries, especially exploratory queries, can be automatically enriched.

As one example, an application can have a graphical user interface that presents a list of field values, each of which can be called a facet. A user can select one or more of the facets, in response to which the application retrieves those documents that match the selected facet. Using automatically selected join fields, additional documents that do not match the facet, but which are automatically joined to one or more of the matching documents, also can be retrieved and made available to the user. Using sales data, an application can retrieve data about customers matching a selected region, and the returned data set can include the customer information, and, in addition, information about the parts these customers ordered can be automatically retrieved.

As another example, an application can retrieve data about customers that recently purchased a selected product. The application also can retrieve the regions the customers live in. As another example, given a selected record about a customer, the system can automatically retrieve data about previous sales activity.

As another example, a query may indicate that sales are down for products where sentiment in documents related to those products is low. The data set of the documents that have the negative sentiment can be automatically joined to the data sets on which this exploratory query is being performed.

In these examples, when a user performs a query on a database, additional data from other data sets is automatically joined and included in the results, and/or in the data set being searched. Such automatic joining is particularly useful where there are multiple distinct databases with similar information but which are not integrated. For example, in a first database, if there is a customer table and a product table that are explicitly related through a foreign key, such a join is readily made. However, if one database has a customer table, and a separate, distinct database has a product table, and the two tables are not related by using a foreign key, then the possibility for an automatic join can be detected using these techniques.

In one particular application, the data sets to be processed are the results of a query that has been applied to a plurality of data sets. The plurality of data sets can be analysed for potential join fields. For each data set in the results, a join operation can be performed using the selected identified fields in the ranked list that results from the statistical analysis. These joined results can be presented on a display.

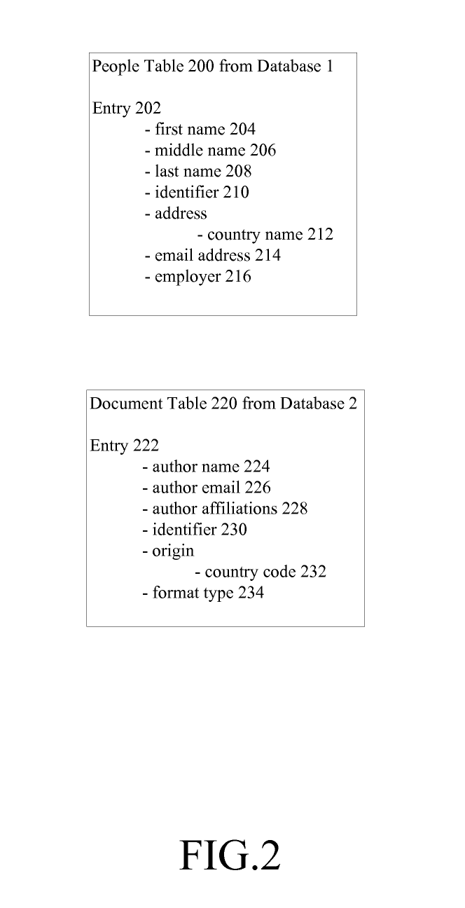

Referring now to FIG. 2, this figure provides an illustrative example of multiple data sets to be analyzed from different databases. Such data sets generally are stored in persistent storage, such as in one or more data files or databases.

For example, a first table 200 from a first database includes data about people. Such a table may include an entry (or row) 202 for each person (such as each customer of a company). Each entry includes data in fields (or columns), where that data represents the person. For example, the table 200 can have a first name field 204, a middle name field 206, a last name field 208, an identifier field 210 for each entry. Consider also one or more address fields, of which one field 212 may be a state or country. An email address 214 for the customer may be stored, as well as an employer name 216.

Similarly, a second table 220 from a second database different from the first database includes data about documents may include an entry (or row) 222 for each document. Each entry includes data in fields (or columns), where that data represents the document. For example table 220 can have an author name field 224, which contains the author's first, middle and last names. An author email address 226 and affiliations 228 (such as corporate or academic affiliations) also can be stored. The table also can have an identifier field (or column) 230 for each entry which stores a value which should be unique for each document. This table also may include various other fields, some of which may be useful for joining tables. Such additional fields can include, for example, one or more origin fields, which may include country code 232 for a country of publication. Another field can indicate a format type 234 of the document, a date of indexing, and so on.

Some fields are not likely good candidates to be selected for joins and can be removed from the analysis data. For example, a field that stores only yes/no values, other binary values, Boolean values, a small set of values, auto-increment values (such as serial numbers), countries, states or other information which are not likely to enable a realistic join operation can be excluded. The exclusion of such fields can be implemented in a number of ways, such as by marking the field as excluded in the data set itself, by analysis of the data set, or through user input indicating exclusion of the field. In the foregoing examples, the country name and country code fields, the identifier fields, and the format type fields can be excluded. Fields that tend to be good fields are those storing postal codes or zip codes, geographical region information, product “stock keeping units” (SKU's), and email addresses.

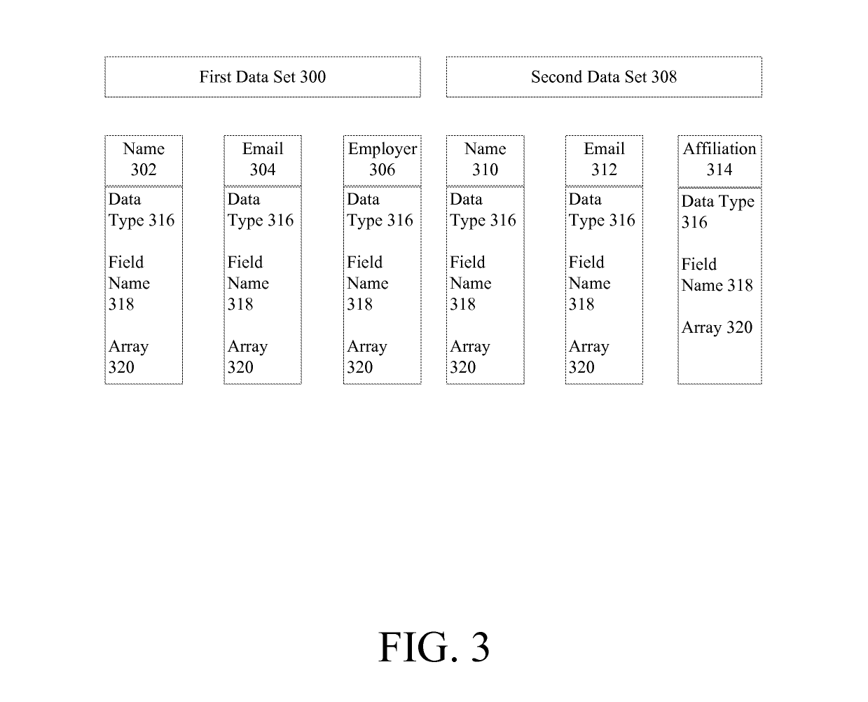

Referring now to FIG. 3, this figure provides an illustrative example of analysis data extracted from the data sets shown in FIG. 2. A data accessor (e.g., in FIG. 1) generally extracts such analysis data from persistent storage and stores the extracted data in memory for ready access by one or more processing units for performing analysis operations. For example, name data can be extracted into a single string, or into a structured array of first name and last name, and optionally additional name fields (e.g., title, middle name, etc.).

In this example, the name, email address and employer fields are extracted from the people table 200 in FIG. 2, and the name, email and author affiliation fields are extracted from the document table 220 in FIG. 2. The other fields shown in FIG. 2 but not shown in FIG. 3 are examples of fields that can be excluded from the analysis. Thus the analysis data includes, in a first data set 300, a name field 302, an email field 304 and an employer field 306. In a second data set 308, there is a name field 310, email field 312 and an affiliation field 314. The data type and field name for the extracted fields can be stored as indicated at 316 and 318 respectively, followed by an array 320 of values extracted from those fields.

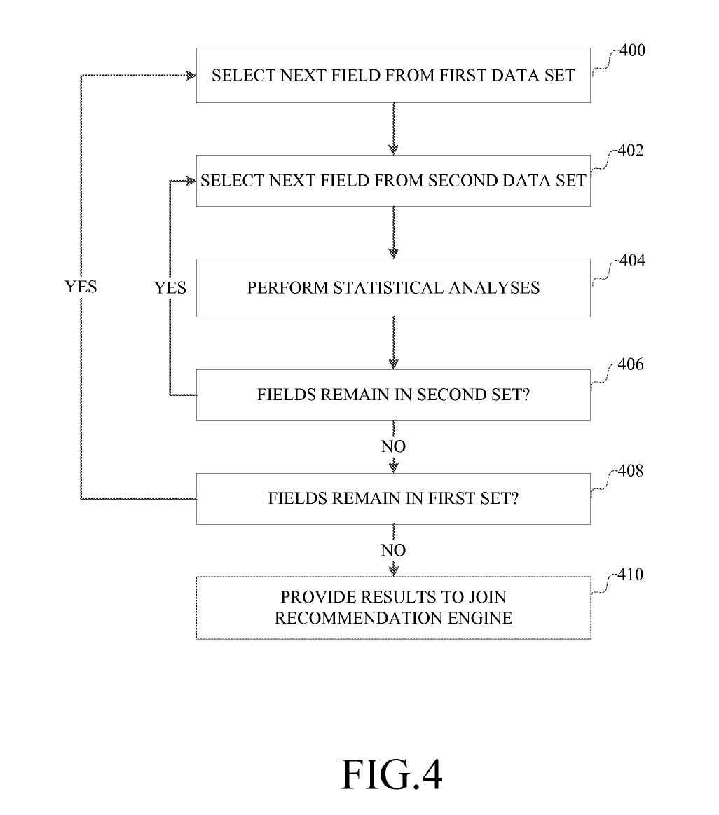

Referring now to FIG. 4, a flow chart describing an implementation of the statistical processing engine will now be described.

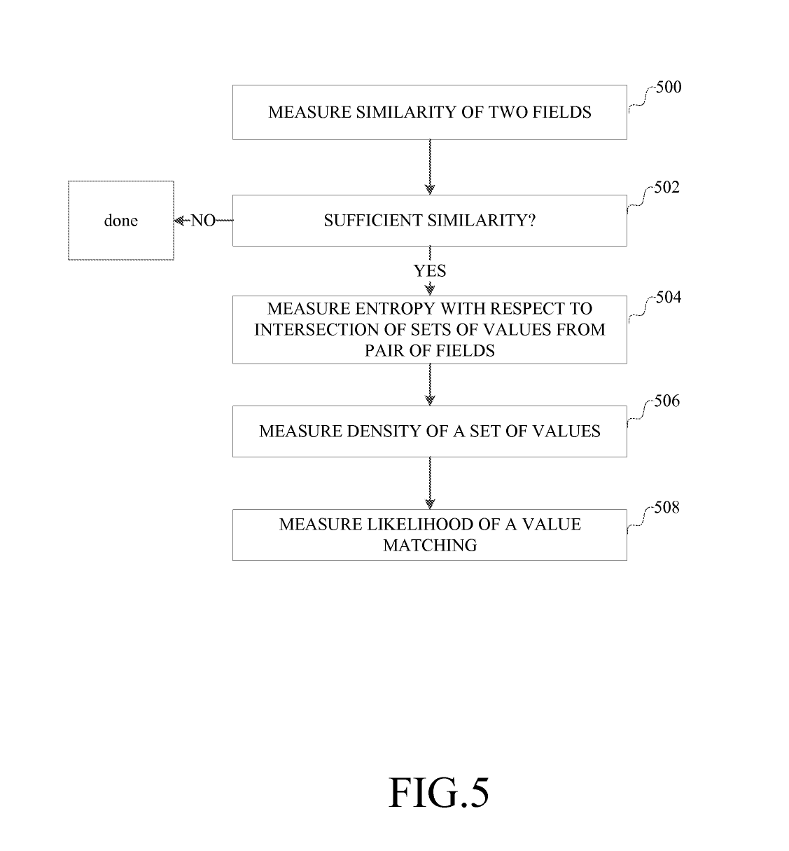

The statistical processing engine selects each possible pair of fields from each data set, excluding the data sets that are not likely to enable a realistic join operation, and performs an analysis using data from the selected pair, and repeats this process for each possible pair. Accordingly, a field from the first data set is selected at 400 and a field from the second data set is selected at 402. The statistical processing engine obtains results for statistical analyses, as indicated at 404 and described in more detail in connection with FIG. 5. The next field in the second data set is selected at 402 if more fields remain, as determined at 406. If no fields remain in the second data set, then the process is repeated with the next field in the first data set, which is selected at 400 if more fields remain in the first data set, as determined at 408. If no fields remain in the first data set, then the statistical analyses of the pairs of data sets is complete. The statistical processing engine can provide the results to a join recommendation engine as indicated at 410. In one implementation, the results for each pair of fields can be provided to the join recommendation engine as the results are produced.

Referring now to FIG. 5, an example implementation of the statistical analyses performed on a pair of fields from two data sets will now be described.

As indicated at 500, similarity of the data in the two fields is measured. In particular, the values of the selected field from the first data set are compared to the values of the selected field from the second data set.

For example, an appropriate similarity (or difference) metric, given the type of the data in the fields, can be used to compare each pair of values. For example, a Euclidean, squared Euclidean or other distance metric can be used for multidimensional numerical values; a Hamming distance or other string matching metric can be used to compare strings; a binary metric can provide a simple equality metric, and so on. The individual comparison results for each value pair can be aggregated to provide a similarity measure between the two data sets.

The similarity measure for the pair of fields is compared to a threshold to determine if there is sufficient similarity in the values of the data fields to make further analysis worthwhile. This threshold can be a user-defined setting, for example. If the comparison indicates that there is insufficient similarity, as illustrated at 502, processing ends, as illustrated at 504. Otherwise, this pair of fields is identified as a potential candidate and further analysis is performed.

In the further analysis, a variety of computations can be performed. In one implementation, the statistical processing engine then measures entropy with respect to an intersection of the sets of values of a pair of fields identified as potential candidates.

In an example implementation, the entropy with respect to the intersection of the sets of values v and w of the identified fields F and G from the pair of data sets A and B can be calculated by computing the entropy of the multiset containing all values in a field F (with repetitions), but after removing (or projecting out) the values which do not occur in G.

A multiset is (S, μ) where S is the (ordinary) set of values and μ is a function from S to N (the non-negative integers). μ(v) is the multiplicity of v. The multiset of values is computed for each field F: (V_{F}, μ_{F}). The entropy H_{FG} of field F with respect to the intersection of (the values in) field F with field G is computed using the following formula:

H_{FG}=H((V_{F}∩V_{G},μ_{F})),

where H is the entropy function:

H((V,μ))=−Σ_{v in V}(P(v)log₂(P(v))),

where P(v) is μ(v)/(Σ_{w in v} μ(w)).

To compute this formula, the computer system computes μ(v), the number of times the element v occurs in field F of table A. Then, the computer system computes −Σ_{v in V} (P(v) log₂(P(v))), wherein the probability P(v) is computed by dividing the number of times v occurs by the total number of elements in the multiset: P(v)=μ(v)/(Σ_{w in V} μ(w)).

This calculation can be normalized by two additional steps. Normalization is performed to enable comparisons between different intersections with different cardinalities, which comparisons allow the intersections with more entropy to be identified. To normalize, a maximum possible entropy Hₘₐₓ=log₂(Σ_{w} μ(w)) for any multiset containing the same number of elements is computed. The normalized entropy with respect to the intersection of fields F and G is then H′_{FG}=(1+H_{FG})/(1+Hₘₐₓ), where 1 is added to avoid division by zero.

In order to make the entropy calculation above more efficient, a random sample of the first data set is computed. A Bloom filter is then applied to the entire second data set.

In addition to entropy with respect to the intersection of the sets of values, density of one or both of the identified fields in the pair of data sets can be measured, as indicated at 508. Density of a field F of a table A is the number of rows of table A which contain any value at all for the field F, i.e., the number of times the field is not null, divided by the total number of rows in table A.

In addition to entropy with respect to the intersection of the sets of values, a likelihood that a value in the identified fields in the first data set matches a value in the identified fields in the second data set can be measured, as indicated at 510. The likelihood of finding a value v from field F of table A in field G of table B is the cardinality of the multiset intersection of F and G divided by the cardinality of the multiset G, or |F intersect G|/|G|. Other set similarity metrics can be used. In order to make this likelihood calculation more efficient, a random sample of the first data set is computed. A Bloom filter is then applied to the entire second data set.

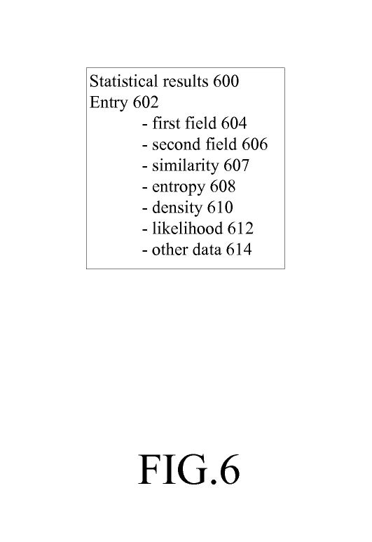

As shown in FIG. 6, the statistical processing engine can store its results in a data structure, generally of the form of a list 600. Such a list can includes an entry 602, for each pair of fields, and indicates the field 604 from the first data set, the field 606 from the second data set, a measure 607 of the similarity, if computed, a measure 608 of the entropy with respect to the intersection of the sets of values of this pair of fields, a measure 610 of density of one or both of the identified fields and a measure 612 of likelihood that a value in the identified field in the first data set matches a value in the identified field in the second data set. One or more additional values 614 also can be stored in the data structure, which can be additional statistical measures, for example. Given such a data structure, the statistical processing engine can populate the entries in the data structure while computing the statistical analyses, such as described in FIGS. 4 and 5. After (or during) statistical processing is completed, the entries can be sorted based on any of the various measures stored in the data structure, which in turn allows a ranked list of pairs of potential joins, if any, to be obtained for a pair of data sets.

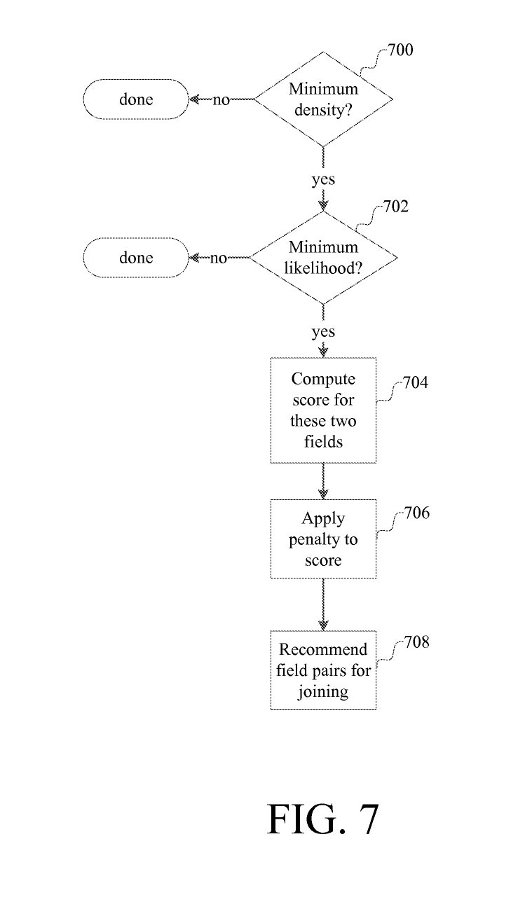

FIG. 7 describes an example implementation.

For a given pair of data sets of values v and values w, respectively from field F of table A and field G of table B, the density of one of the sets (e.g., field F) is computed and compared to a threshold, as indicated at 700. If the density of one of the fields does not exceed a minimum, e.g., 10%, then this field pair combination (e.g., field F and field G) is discarded as a possible recommendation for joining

Otherwise, processing continues and the likelihood of finding a value from a field F in table A in a field G in table B is then computed and compared to a threshold, as indicated at 702. This likelihood is the size of the multiset intersection of fields F and G divided by the size of the set of values v in field F. If this likelihood does not exceed a minimum, e.g., 50%, then this field pair combination is discarded as a possible recommendation for joining.

Next, a raw score for this pair of fields F and G is then computed 704. This raw score can be, for example, the normalized intersection entropy given the sets of values v and values w, respectively from field F of table A and field G of table B. This raw score can be further scaled by one or both of the density or likelihood values used in steps 700 and 702. A penalty can be applied 706 to this raw score, for example, if the data type or field names of the fields F and G do not match. Note that in the foregoing explanation, the various set operations are multiset operations.

For example, the penalty can be a scaling factor. Such a scaling factor can be selected so as to penalize fields that do not match, but would permit non-matching fields to be used in the event that no matches are found. As an example, if the data types are unjoinable (e.g., money, floats, doubles, date data types), the penalty can be a scaling factor of 0.2. If the data types do not match, then the penalty can be a scaling factor of 0.5. If the names of the fields do not match, then the penalty can be a scaling factor of between 0.5 to 1.0. For example, if one of the field names is a prefix of the other (e.g., “comp” is a prefix of “company”), then the scaling factor can be higher (e.g., 0.95). A distance metric applied to the field names also can be used as part of a function to compute a scaling factor. For example, the Levenshtein edit distance between two names divided by the minimum lengths of the two names, subtracted from one but limited to a minimum value such as 0.5, can be used to compute a scaling factor.

Given a score for a pair of fields F and G after step 706, a recommendation can be made 708 regarding that pair of fields. A minimum score optionally can be enforced by applying a threshold, such as 0.5, to the score for the pair of fields. Different pairs of fields can be ranked by their score as part of the recommendation. The computer system can present a user interface to a user that allows the user to select a pair of fields based on these scores. The user interface can include information about the different fields (e.g., field names, types and tables in which they reside) and optionally the score for each pair of fields.

The recommendation generally will take one of four forms. For example, given a table A, this analysis could be performed by analyzing multiple other tables, of which one is table B. In such a case, suitable fields in table A are compared to suitable fields in other tables to identify good fields to support a join operation. The analysis identifies a field F in table A to be joined with a field G in a table B.

As another example, given a table A and a field F, this analysis could be performed by analyzing multiple other tables, of which one is table B. In such a case, field F in table A is compared to suitable fields in other tables to identify good fields to support a join operation. The analysis identifies a field G in table B to be joined with the specified field F in table A.

As another example, given a table A and a table B, this analysis could be performed by analyzing the fields of both tables A and B. In such a case, suitable fields in table A are compared to suitable fields in table B to identify good fields to support a join operation between the two tables A and B. The analysis identifies a field G in table B to be joined with a field F in table A.

As another example, given a field F in a table A and a table B, this analysis could be performed by analyzing the fields of table B with respect to field F of table A. In such a case, suitable fields in table B are compared to field F in table A to identify good fields to support a join operation using field F in table A and a field in table B. The analysis identifies a field G in table B to be joined with the specified field F in table A.

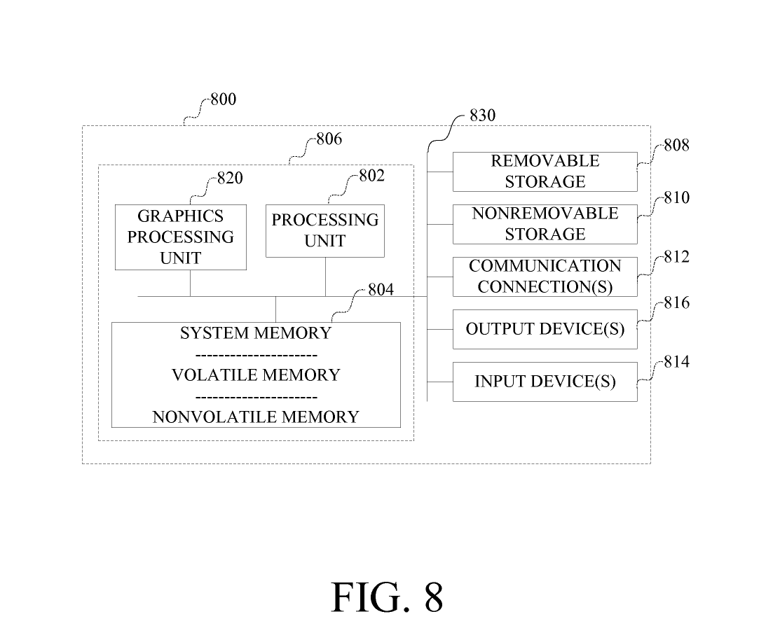

FIG. 8 illustrates an example computer with which the various components of the system of FIGS. 1 to 8 can be implemented. The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, network PCs, minicomputers, mainframe computers, and distributed computing environments that include any of the above types of computers or devices, and the like.

With reference to FIG. 8, an example computer 800 includes at least one processing unit 802 and memory 804. The computer can have multiple processing units 802. A processing unit 802 can include one or more processing cores (not shown) that operate independently of each other. Additional co-processing units, such as graphics processing unit 820, also can be present in the computer. The memory 804 may be volatile (such as dynamic random access memory (DRAM) or other random access memory device), non-volatile (such as a read-only memory, flash memory, and the like) or some combination of the two. This configuration of memory is illustrated in FIG. 8 by dashed line 806. The computer 800 may include additional storage (removable and/or non-removable) including, but not limited to, magnetically-recorded or optically-recorded disks or tape. Such additional storage is illustrated in FIG. 8 by removable storage 808 and non-removable storage 810. The various components in FIG. 8 are generally interconnected by an interconnection mechanism, such as one or more buses 830.

A computer storage medium is any medium in which data can be stored in and retrieved from addressable physical storage locations by the computer. Computer storage media includes volatile and nonvolatile memory, and removable and non-removable storage media. Memory 804 and 806, removable storage 808 and non-removable storage 810 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 800 may also include communications connection(s) 812 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 812 are devices, such as a network interface or radio transmitter, that interface with the communication media to transmit data over and receive data from communication media.

Computer 800 may have various input device(s) 814 such as a keyboard, mouse, pen, camera, touch input device, and so on. Output device(s) 816 such as a display, speakers, a printer, and so on may also be included. All of these devices are well known in the art and need not be discussed at length here. The input and output devices can be part of a housing that contains the various components of the computer in FIG. 8, or can be separable from that housing and connected to the computer through various connection interfaces, such as a serial bus, wireless communication connection and the like. The various storage 810, communication connections 812, output devices 816 and input devices 814 can be integrated within a housing with the rest of the computer, or can be connected through input/output interface devices on the computer, in which case the reference numbers 810, 812, 814 and 816 can indicate either the interface for connection to a device or the device itself as the case may be.

Each component (which also may be called a “module” or “engine” or the like), of a system such as described in FIGS. 1-5 above, and which operates on a computer, can be implemented using the one or more processing units of one or more computers and one or more computer programs processed by the one or more processing units. A computer program includes computer-executable instructions and/or computer-interpreted instructions, such as program modules, which instructions are processed by one or more processing units in the one or more computers. Generally, such instructions define routines, programs, objects, components, data structures, and so on, that, when processed by a processing unit, instruct the processing unit to perform operations on data or configure the processor or computer to implement various components or data structures. Such components have inputs and outputs by accessing data in storage or memory and storing data in storage or memory.

This computer system may be practiced in distributed computing environments where operations are performed by multiple computers that are linked through a communications network. In a distributed computing environment, computer programs may be located in both local and remote computer storage media.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

It should be understood that the subject matter defined in the appended claims is not necessarily limited to the specific implementations described above. The specific implementations described above are disclosed as examples only.

What is claimed is:

1. A computer-implemented process comprising:
receiving a plurality of data sets, each data set having a plurality of entries, each entry having a plurality of fields, wherein a field in the plurality of fields has at least one value;
for each pair of data sets in the plurality of data sets:
comparing the values of fields in a first data set in the pair of data sets to the values of fields in a second data set in the pair of data sets to identify fields having substantially similar sets of values, and
measuring entropy with respect to an intersection of the sets of values of the identified fields from the pair of data sets; and
suggesting fields for a join operation between any pair of data sets in the plurality of data sets, based at least on the measured entropy with respect to the intersection of the sets of values of the identified fields from the pair of data sets.

2. The computer-implemented process of claim 1, wherein, for each pair of data sets in the plurality of data sets, the process further comprises:
measuring density of at least one of the identified fields in the pair of data sets; and
wherein suggesting fields is further based at least on the measured density.

3. The computer-implemented process of claim 2, wherein, for each pair of data sets in the plurality of data sets, the process further comprises:
measuring a likelihood that a value in the identified field in the first data set matches a value in the identified field in the second data set; and
wherein suggesting fields is further based at least on the measured likelihood.

4. The computer-implemented process of claim 1, wherein, for each pair of data sets in the plurality of data sets, the process further comprises:
measuring a likelihood that a value in the identified field in the first data set matches a value in the identified field in the second data set; and
wherein suggesting fields is further based at least on the measured likelihood.

5. The computer-implemented process of claim 1, wherein suggesting comprises:
generating a ranked list of identified fields.

6. The computer-implemented process of claim 5, wherein suggesting comprises:
presenting the ranked list on a display; and
receiving an input indicating a selection of identified fields from the ranked list.

7. The computer-implemented process of claim 5, wherein suggesting comprises:
the processor selecting identified fields from the ranked list.

8. The computer-implemented process of claim 7, further comprising:
presenting the selected identified fields on a display.

9. The computer-implemented process of claim 1, wherein the plurality of data sets includes N data sets, where N is a positive integer greater than 2.

10. The computer-implemented process of claim 7, further comprising:
receiving a query results for a query applied to the plurality of data sets;
for each data set in the results, performing a join operation using the selected identified fields in the ranked list.

11. The computer-implemented process of claim 10, further comprising:
presenting the joined results on a display.

12. The computer-implemented process of claim 1, wherein the plurality of data sets includes data from different tables in a relational database management system.

13. The computer-implemented process of claim 1, wherein the plurality of data sets includes data from different tables in an object oriented database system.

14. The computer-implemented process of claim 1, wherein the plurality of data sets includes data from different tables in an index of documents.

15. A computer system comprising:
memory in which a plurality of data sets are stored, each data set having a plurality of entries, each entry having a plurality of fields, wherein a field in the plurality of fields has at least one value;
one or more processing units programmed by a computer program to be instructed to, for each pair of data sets in the plurality of data sets:
compare the values of fields in a first data set in the pair of data sets to the values of fields in a second data set in the pair of data sets to identify fields having substantially similar sets of values, and
measure entropy with respect to an intersection of the sets of values of the identified fields from the pair of data sets; and
suggest fields for a join operation between any pair of data sets in the plurality of data sets, based at least on the measured entropy with respect to the intersection of the sets of values of the identified fields from the pair of data sets.

16. The computer system of claim 15, wherein, for each pair of data sets in the plurality of data sets, the one or more processing units are further programmed to be instructed to:
measure density of at least one of the identified fields in the pair of data sets; and
wherein suggesting fields is further based at least on the measured densities.

17. The computer system of claim 16, wherein, for each pair of data sets in the plurality of data sets, the one or more processing units are further programmed to be instructed to:
measure a likelihood that a value in the identified field in the first data set matches a value in the identified field in the second data set; and
wherein suggesting fields is further based at least on the measured likelihood.

18. The computer system of claim 15, wherein, for each pair of data sets in the plurality of data sets, the one or more processing units are further programmed to be instructed to:
measure a likelihood that a value in the identified field in the first data set matches a value in the identified field in the second data set; and
wherein suggesting fields is further based at least on the measured likelihood.

19. The computer system of claim 15, wherein suggesting comprises:
generating a ranked list of identified fields.

20. The computer system of claim 19, wherein suggesting comprises:
presenting the ranked list on a display; and
receiving an input indicating a selection of identified fields from the ranked list.
